(19) United States
(12) Patent Application Publication
(10) Pub. No.: US 2013/0068643 A1
(43) Pub. Date: Mar. 21, 2013

(54) FIXED SEAT FOR A TOOL

(71) Applicant: Chih-Chien HSIEH, Taichung City (TW)

(72) Inventor: Chih-Chien HSIEH, Taichung City (TW)

(21) Appl. No.: 13/238,275

(22) Filed: Sep. 21, 2011

(51) Int. Cl. B25H 3/00

(52) U.S. Cl. 206/349

(57) ABSTRACT

A fixed seat for a tool has a sleeve joint pillar set into a polygonized pillar, of which the circumference side part contains abutment surfaces and edges. The abutment surface can abut the groove wall of the sleeve's square casing groove, and said edge or margin part permits spanwise locking of the sleeve during its rotation. A positioning convex part is protruded from an abutment surface on the circumference side part of the sleeve joint pillar, and interlocked with the positioning concave camber on the groove wall of the square casing groove. A lateral through-hole is set onto one side of the sleeve joint pillar. Both ends of the lateral through-hole pass through separately the abutment surface on the circumference side part of the sleeve joint pillar. A wall rim is formed between the abutment surface and the lateral through-hole, so that the positioning convex part could be squeezed flexibly.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fixed seat for a tool, and more particularly to an innovative one which permits location of the sleeve by means of rotary fastening.

2. Description of Related Art Including Information Disclosed Under 37 CFR 1.97 and 37 CFR 1.98.

The fixed seat for a tool referred to herein is an auxiliary seat for locating a sleeve. The configuration of such fixed seat may vary from different sleeves, e.g.: single-or multiple-piece arrangement with use of lifting subs or retaining frames.

Said fixed seat for a tool is structurally configured in a way that a square pillar is generally protruded from the seat body for setting of a square casing groove on one end of existing sleeve. The sleeve is positioned by the proper mating of said square pillar with the square casing groove. Yet, the following shortcomings are still observed during actual applications.

It is very difficult to control the mating tightness of the square pillar and square casing groove in the manufacturing process, since any dimensional error of either the square pillar or square casing groove will affect the sleeving tightness. In the event of extreme tightness, the users may find it inconvenient to take, assemble or place the sleeve. Conversely, loose mating of the square pillar and square casing groove will lead to unstable sleeving and disengagement of the sleeve.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique structural configuration of the present invention wherein the “fixed seat for tool” mainly comprises: a sleeve joint pillar with abutment surface and edge or margin part, positioning convex parts and lateral through-holes, a novel fixed seat for tool is adopted for locating sleeve by means of rotary fastening. The sleeve is rotated in such a manner that the positioning concave camber of the square casing groove is interlocked with the positioning convex part of the sleeve joint pillar, so the positioning convex part presents retraction flexibility when a flexible wall rim is formed with the arrangement of the lateral through-hole. Hence, a bigger mating error is allowed between the sleeve's square casing groove and sleeve joint pillar without affecting the locating robustness of the sleeve. Moreover, this enables to fetch and assemble the sleeve more smoothly, and also improves its locating robustness and operational convenience. On the other hand, with the arrangement of said lateral through-hole, the positioning convex part can be retracted flexibly, so the present invention features simple structure and ease of manufacturing while maintaining satisfactory structural strength of the sleeve joint pillar.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the present invention wherein the fixed seat for a tool and sleeve are assembled together.

FIG. 2 is an exploded sectional view of the fixed seat for a tool and sleeve of the present invention.

FIG. 3 is an assembled sectional view of the fixed seat for a tool and sleeve of the present invention.

FIG. 4 is a schematic view of the present invention wherein the sleeve joint pillar of the fixed seat for a tool and the sleeve are set and then positioned rotarily.

FIG. 5 is a schematic view of the present invention wherein the sliding connector base of the fixed seat for tool is assembled onto the long framework.

FIG. 6 is a schematic view of the present invention wherein a lifting and clamping portion is formed by the under side of the sleeve joint pillar of the fixed seat for a tool.

FIG. 7 is a schematic view of the present invention wherein a burglar-proof lock pillar is set on the sleeve joint pillar of the fixed seat for a tool.

FIG. 8 is a schematic view of the present invention wherein the sleeve joint pillar of the fixed seat for tool and the sleeve are set into an anti-theft state.

FIG. 9 is a schematic view showing operation of the present invention wherein the burglar-proof lock pillar is removed after the sleeve joint pillar of the fixed seat for a tool and the sleeve are set.

FIG. 10 is a plan view of a preferred embodiment of the fixed seat for tool of the present invention.

### DETAILED DESCRIPTION OF THE INVENTION

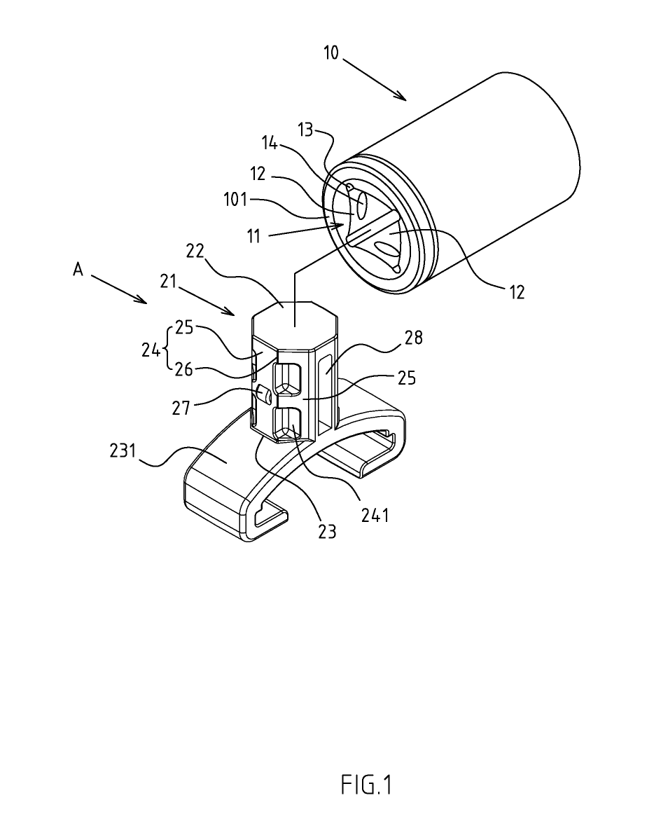

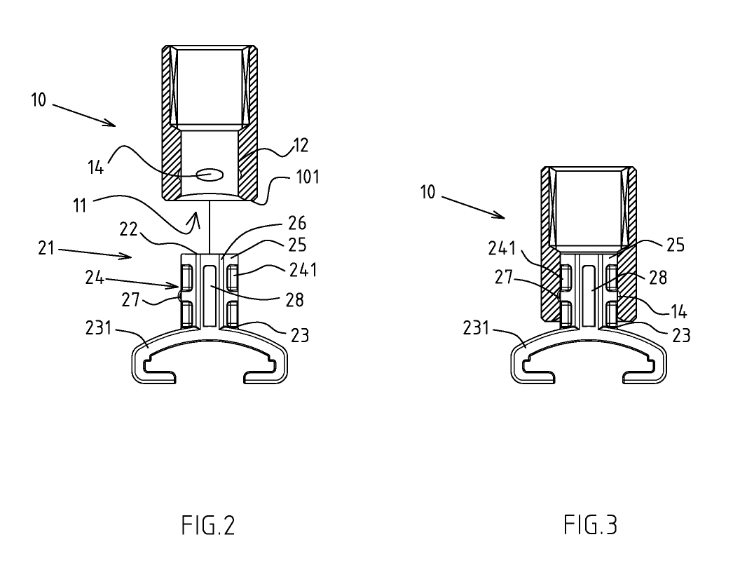

FIGS. 1-7 depict preferred embodiments of a fixed seat of the present invention, which, however, are provided for only explanatory objective for patent claims. Said fixed seat for a tool A is exclusively used for setting and locating the sleeve 10 (including customized and non-customized specifications) by rotary fastening. The toolkit side 101 of said sleeve 10 is provided with a square casing groove 11 to define four groove walls 12 and edges 13 set between the groove walls 12. A positioning concave camber 14 is set deeply onto at least a groove wall 12.

The fixed seat for tool A comprises a sleeve joint pillar 21, set into a polygonized pillar to define a top side 22, a under side 23 and circumference side part 24, of which the circumference side part 24 contains a few abutment surfaces 25 and convex corners 26 formed between the abutment surfaces 25. Said abutment surface 25 can be abutted onto the groove wall 12 of the square casing groove 11 on the toolkit side 101 of the sleeve 10, and said convex corners 26 permits spanwise locking of the sleeve 10 during its rotation, such that the sleeve joint pillar 21 could be tightly mated with the sleeve 10. Moreover, slots 241 are arranged at interval onto the circumference side part 24 for removing feedstock with uniform wall thickness and reducing the sleeving friction area;

At least a positioning convex part 27 is protruded from at least an abutment surface 25 on the circumference side part 24 of the sleeve joint pillar 21. The positioning convex part 27 is interlocked with the positioning concave camber 14 on the groove wall 12 of the square casing groove 11 at the toolkit side 101 of the sleeve 10, enabling secure locking of the sleeve 10.

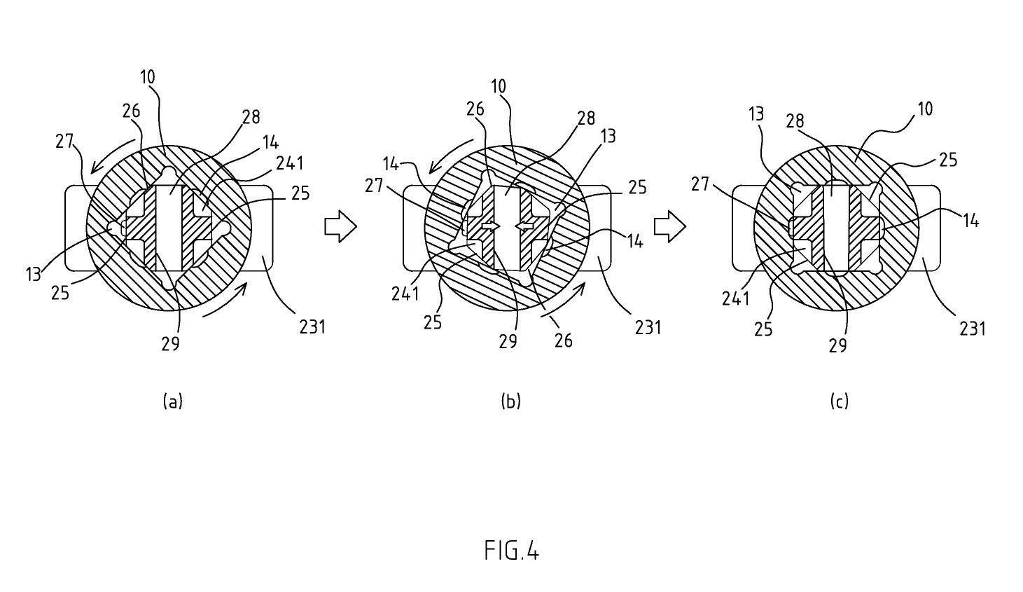

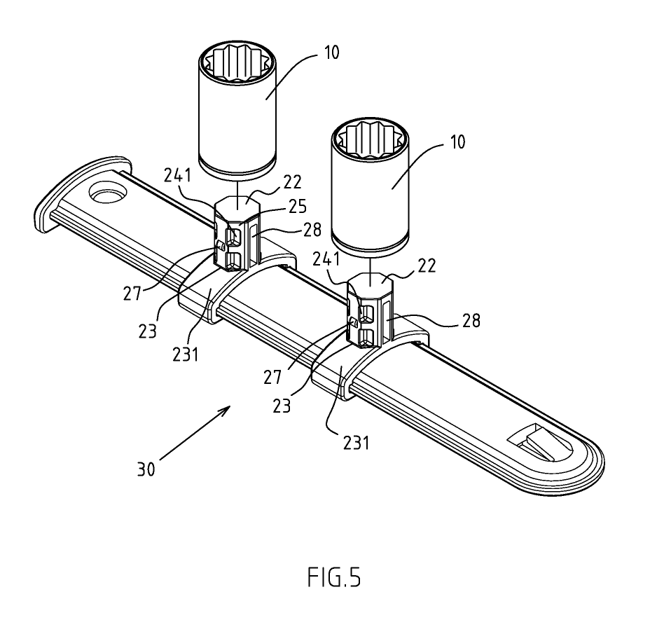

At least a lateral through-hole 28 is set onto one side of the sleeve joint pillar 21 without positioning convex part 27. Both ends of the lateral through-hole pass through separately the abutment surfaces 25 on the circumference side part 24 of the sleeve joint pillar 21. With the setting of the lateral through-hole 28, a wall rim 29 (shown in FIG. 4) is formed between the abutment surface 25 with positioning convex part 27 and the lateral through-hole 28, so that the sleeve joint pillar 21 could be squeezed flexibly without affecting the overall structural strength.

The service conditions and preferred embodiments of the fixed seat for tool are described below:

Referring to FIG. 4, when the sleeve joint pillar 21 of the preferred embodiment is assembled into the square casing groove 11 on the toolkit side 101 of the sleeve 10 but not rotated, the positioning convex part 27 is positioned at the edge 13 of the square casing groove 11 (indicated by (a) in FIG. 4), and the sleeve joint pillar 21 is squeezed by rotating the sleeve 10, so as to enable retraction of the positioning convex part 27 on the abutment surface 25 of the sleeve joint pillar 21 (indicated by (b) in FIG. 4). Said convex corners 26 and the groove wall 12 in the square casing groove 11 permit spanwise locking When rotated to a preset angle (45° in this preferred embodiment), the positioning convex part 27 is interlocked with the positioning concave camber 14 on the groove wall 12 of the square casing groove 11 at the toolkit side 101 of the sleeve 10(indicated by (c) in FIG. 4), enabling secure locking of the sleeve 10.

Referring also to FIG. 5, a sliding connector base 231 is formed by the under side 23 of the sleeve joint pillar 21, and also sleeved onto a long framework 30 in a sliding state. The long framework 30 can be coupled with several sleeve joint pillars 21 for orderly accommodation and space-saving purposes.

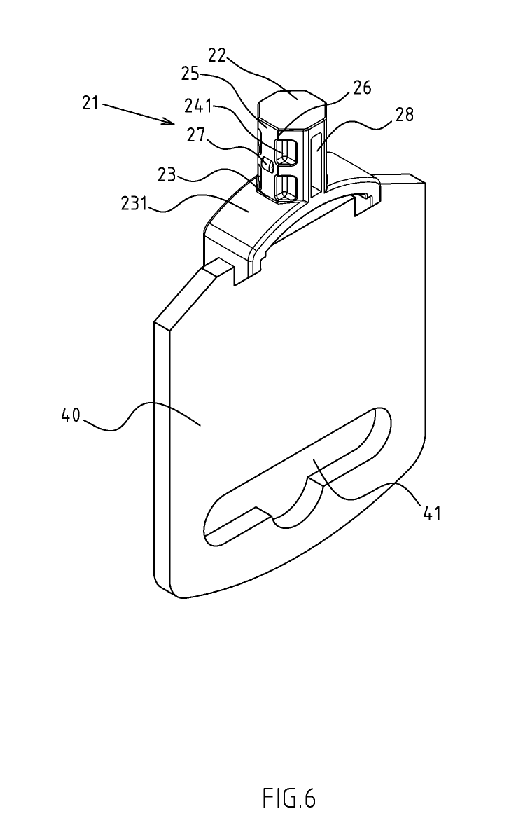

Referring also to FIG. 6, another preferred embodiment of the fixed seat for a tool of the present invention, wherein an expanded lifting and clamping portion 40 is formed by the under side 23 of the sleeve joint pillar 21. A lifting hole 41 is set at a preset location of the lifting and clamping portion 40, so as to lift the sleeves 10 on display rack for the consumers.

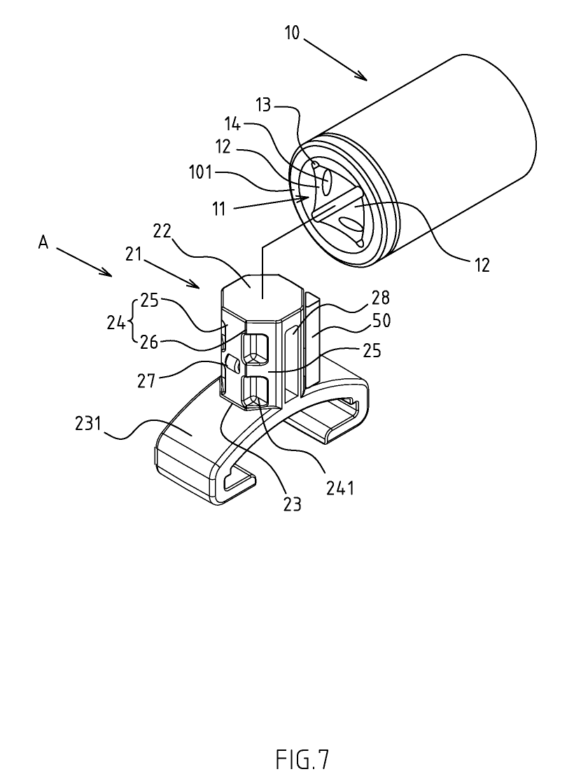

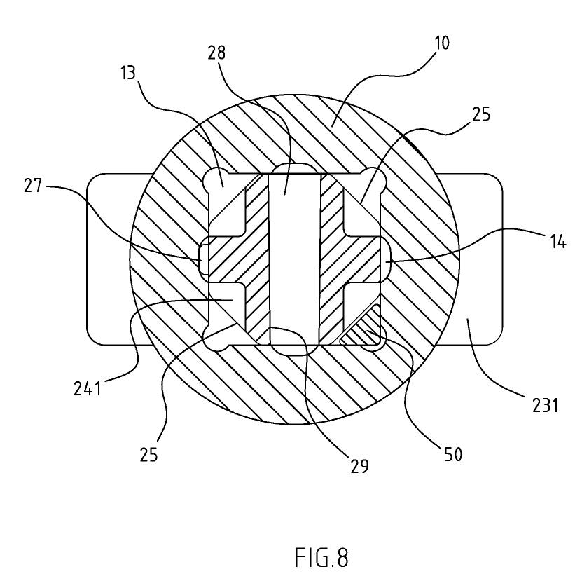

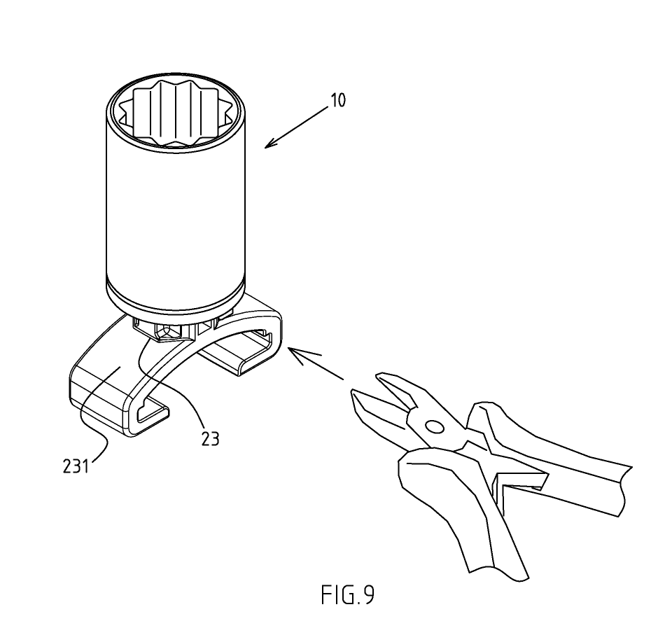

Referring also to FIGS. 7 and 8, another preferred embodiment of the fixed seat for a tool of the present invention, wherein a burglarproof lock pillar 50 is set externally at a spacing with an abutment surface 25 of the sleeve joint pillar 21. The burglarproof lock pillar 50 can also be inserted into a edge 13 of the square casing groove 11 at the toolkit side 101 of the sleeve 10, such that the sleeve 10 can be positioned fixedly to prevent any intended theft. Anti-theft state could be eliminated only when the burglarproof lock pillar 50 is removed (shown in FIG. 9), so the structure without burglarproof lock pillar 50 is resumed as indicated in FIG. 1.

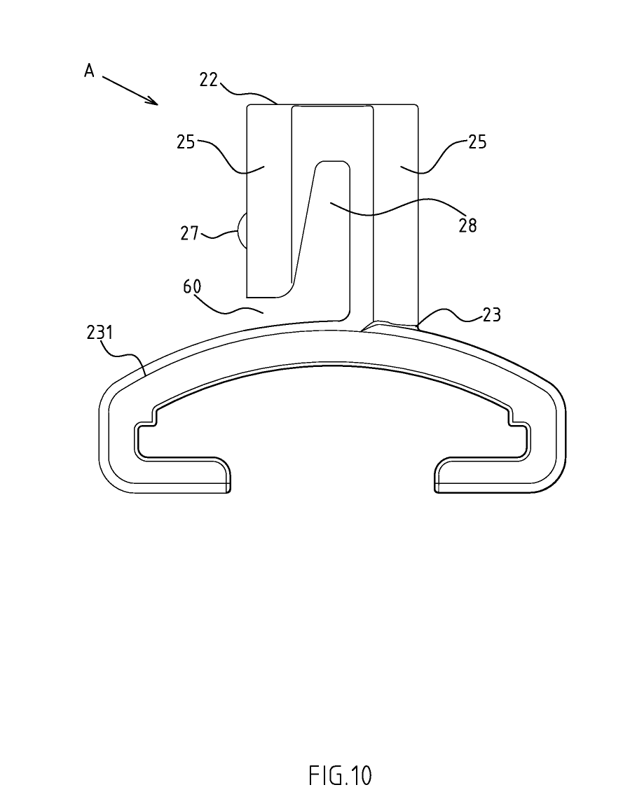

Referring also to FIG. 10, another preferred embodiment of the fixed seat for tool of the present invention, wherein a notch 60 is formed laterally on the under side 23 of the sleeve joint pillar 21 with positioning convex part 27, and linked to the through-hole 28, such that the positioning convex part 27 could be squeezed more flexibly.

I claim:

1. A fixed seat for tool, exclusively used for setting and locating the sleeve by rotary fastening; the toolkit side of said sleeve is provided with a square casing groove to defined four groove walls and edges between the groove walls; and a positioning concave camber is set deeply onto at least a grooved wall; the fixed seat for tool comprising:
a sleeve joint pillar, set into a polygonized pillar to define a top side, a under side and circumference side part, of which the circumference side part contains a few abutment surfaces and convex corners formed between the abutment surfaces; said abutment surface can be abutted onto the groove wall of the sleeve's square casing groove, and said convex corners permits spanwise locking of the sleeve during its rotation;
at least a positioning convex part, protruded from at least an abutment surface on the circumference side part of the sleeve joint pillar; and the positioning convex part is interlocked with the positioning concave camber on the groove wall of the sleeve's square casing groove, enabling secure locking of the sleeve;
at least a lateral through-hole, set onto one side of the sleeve joint pillar without positioning convex part; both ends of the lateral through-hole pass through separately the abutment surface on the circumference side part of the sleeve joint pillar;
with the setting of the lateral through-hole, a wall rim is formed between the abutment surface with positioning convex part and the lateral through-hole, so that the positioning convex part could be squeezed flexibly.

2. The structure defined in claim 1, wherein a sliding connector base is formed by the under side of the sleeve joint pillar, and also assembled onto a long framework in a sliding state.

3. The structure defined in claim 1, wherein an expanded lifting and clamping portion is formed by the under side of the sleeve joint pillar; and a lifting hole is set on the lifting and clamping portion, so as to lift the sleeve joint pillar on display rack for the consumers.

4. The structure defined in claim 1, wherein slots are arranged at interval onto the circumference side part of the sleeve joint pillar.

5. The structure defined in claim 1, wherein a burglarproof lock pillar is set externally at a spacing with an abutment surface of the sleeve joint pillar; the burglarproof lock pillar can also be inserted into an edge or margin part of the square casing groove at the toolkit side of the sleeve, such that the sleeve can be positioned fixedly to prevent any intended theft; and anti-theft state could be eliminated only when the burglarproof lock pillar is removed.

6. The structure defined in claim 1, wherein the fixed seat for tool is made of plastic or metal composite materials.

7. The structure defined in claim 1, wherein a notch is formed laterally on the under side of the sleeve joint pillar with positioning convex part, and linked to the through-hole, such that the positioning convex part could be squeezed more flexibly.
